(19) United States
(12) Patent Application Publication
(10) Pub. No.: US 2007/0041168 A1
(43) Pub. Date: Feb. 22, 2007

(54) Luminous container

(76) Inventor: Caroline Marie Dodd, London (GB)

Correspondence Address: RANKIN, HILL, PORTER & CLARK, LLP, 925 EUCLID AVENUE, SUITE 700, CLEVELAND, OH, 44115-1405, US

(21) Appl. No.: 10/568,923

(22) PCT Filed: Aug. 23, 2004
(86) PCT No.: PCT/GB04/03603

§ 371 Date: Oct. 9, 2006

(30) Foreign Application Priority Data
Aug. 21, 2003 (GB) 0319639.1

(51) Int. Cl. F21K 2/00; A45C 15/06

(52) U.S. Cl. 362/34; 362/156

(57) ABSTRACT

A luminous container (1) comprises a container body (2) to support one or more objects (10) and a luminous surface (8) on or in the container, wherein, in use, said luminous surface glows in the dark identifying the container and/or the or each object.

The present invention relates to a luminous container.

It is common practice to place objects such as glasses by ones bedside at night. If one needs to perform a task when it is dark, it is difficult to find the glasses in order to see. This can be dangerous especially for older people who can trip and fall over without good vision.

The invention seeks to provide a container to support objects such as glasses to help locate such objects at night.

According to the present invention, there is provided a luminous container for identifying objects in the dark. In one aspect, the invention provides a luminous container comprising a container body to support one or more objects and a luminous surface on or in the container, in use said luminous surface glowing in the dark identifying the container and/or the or each object.

Preferably; the container is transparent. Any suitable transparent material may be used to form the container, for example transparent plastic, the idea being to maximise the visibility of the luminous surface.

The container is preferably a bedside container, that is, a container suitable for placing on a bedside table, for example.

The luminosity of the luminous surface can be provided by any suitable means, although it is preferred to use glow in the dark paint. Paints of this type are readily available and can, for example, be obtained from Pete's Luminous Creations (further details can be found at www.glo-net.com). Typically, these paints require a minimal period of charging, usually at least ten minutes, by exposure to light, and thereafter provide a continuous glow in dark conditions for many hours. Paints providing several several hours of continuous luminosity are preferred, with those providing 8 hours or more being particularly suitable.

In one aspect, the luminous surface comprises glow in the dark paint provided on one or more surfaces of the container itself.

In another aspect, the luminous surface comprises a separate luminous backing plate. Preferably, this is designed so as to fit snugly in the container. The luminous backing plate preferably comprises glow in the dark paint as the means of providing luminosity. Alternatively, the luminous surface may be provided as a combination of glow in the dark paint on one or more surfaces of the container, in combination with a luminous backing plate.

The luminous backing plate may be of any suitable material, for example plastic. A transparent luminous backing plate may be used if desired, for instance comprising a sheet of transparent plastic and glow in the dark paint on the surface of one or more sides thereof. This has the advantage of providing additional luminosity, in particular when a transparent luminous backing plate is used in combination with a transparent container.

In a preferred embodiment, the container comprises a wallet of transparent material.

Preferably, the container is a wallet of transparent material and the luminous surface is provided on a backing plate in the wallet, in use an object is placed on the backing plate and the object is visible when the backing plate glows in the dark.

In another embodiment, the container is in the form of a glasses case, said case supporting a surface which is luminous, in use said container being visible in the dark when the luminous surface glows.

In another embodiment the container is in the form of a plate supporting a peripheral skirt having an elasticated free edge, said plate supporting a luminous surface, and an object being locatable in a pocket formed by said skirt with said object being insertable and withdrawable through the expandable aperture formed by said elasticated free edge, in use said container being visible in the dark when the luminous surface glows.

By way of illustration, the form of the peripheral skirt is preferably one resembling that of a fitted bedsheet or mattress cover. Such a skirt can be easily fitted over a luminous plate. Preferably, the skirt is of transparent plastic, most preferably transparent PVC.

In a further embodiment, the container comprises a case for an object, which case comprises a luminous surface on or in the case, and a drawer comprising a further luminous surface in or on the drawer, the drawer when opened presenting an additional luminous surface.

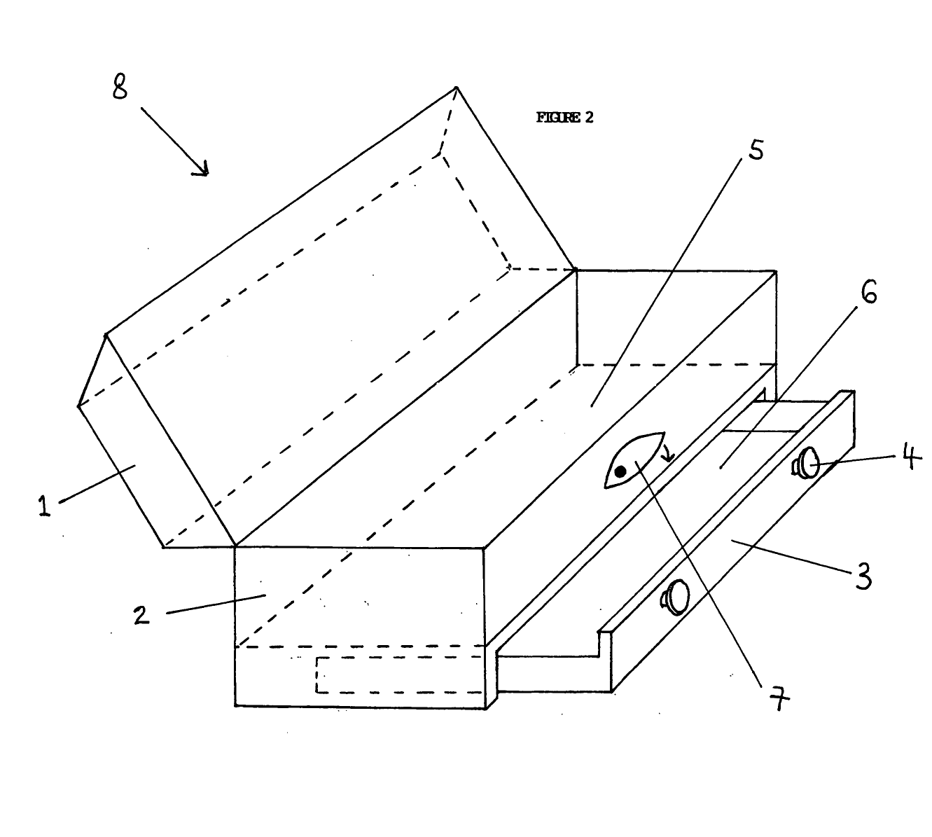

Preferably, the case is transparent. The case also preferably comprises a lid. An example of this embodiment is illustrated in FIG. 2. Preferably, the case is a glasses case.

In a yet further embodiment, the container comprises a case for an object, which case comprises a luminous surface on or in the case, and on one or more sides of the case an elasticated free edge forming an expandable aperture, said object being insertable into and withdrawable from said case through said aperture.

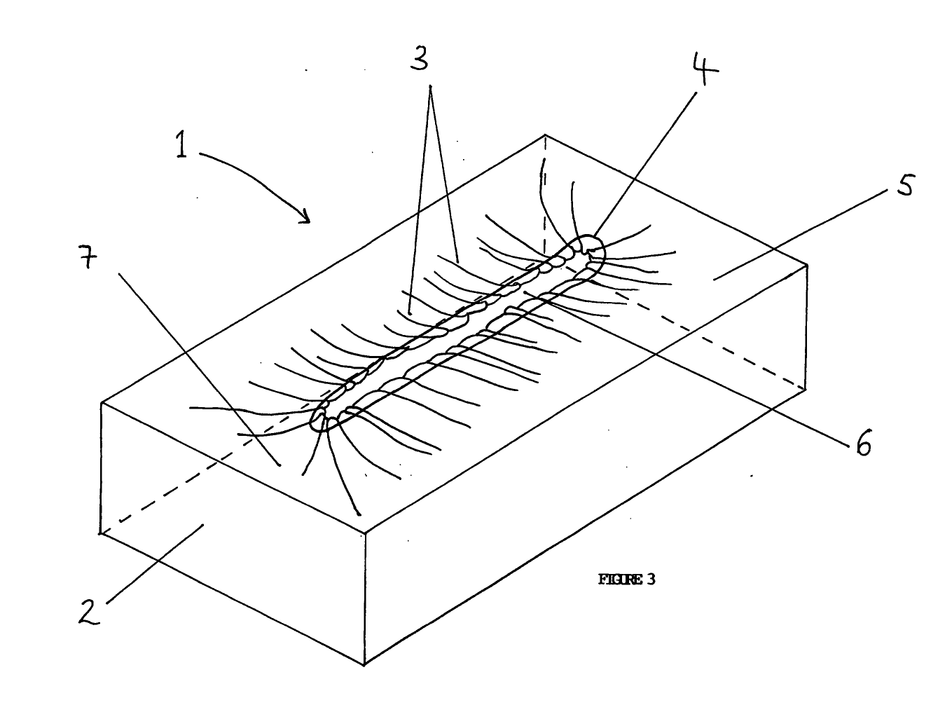

Preferably, one or more sides of the case comprises a flexible material, preferably flexible plastic, which forms the elasticated free edge. A flexible sheet of polyvinylchloride (PVC) is suitable, for example. Preferably, the expandable aperture is formed by gathering an edge of the flexible material with an elastic member, so as to form an elasticated free edge. An elastic or rubber band is, for example, suitable for this purpose, as illustrated in FIG. 3. The case is preferably transparent. The flexible material is also preferably transparent, so as to provide maximum visibility of the luminous surface. The size and shape of the expandable should be such as to allow easy insertion and removal of the desired object.

In all the embodiments described, preferably in use the object, or at least an outline thereof, is visible in the dark when the luminous surface glows.

In order that the invention may be more fully understood, particular embodiments of the invention will now be described with reference to the accompanying drawings in which:

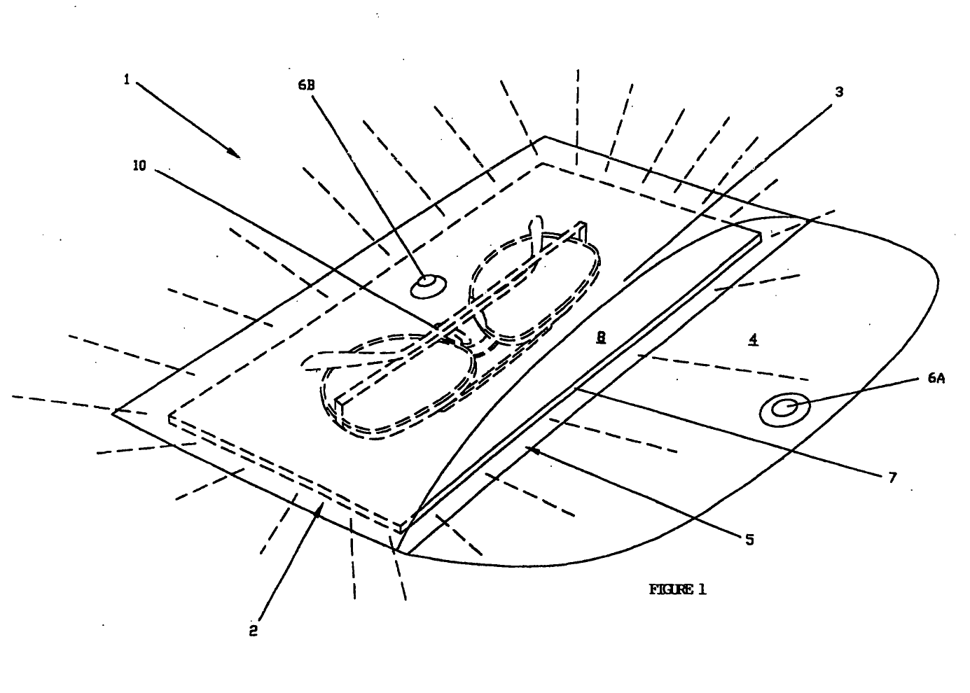

FIG. 1 shows a perspective view of an embodiment where the container is in the form of a transparent wallet containing a luminous backing plate.

FIG. 2 shows a perspective view of an embodiment comprising a case with a drawer comprising an additional luminous surface.

FIG. 3 shows a perspective view of an embodiment comprising a container with an elasticated free edge on the upper surface thereof.

Referring to FIG. 1 there is shown a luminous container 1. Container 1 comprises a container body in the form of a wallet 2 of transparent material having a wallet envelope 3 with a flap 4 which folds open and closed to open and close an envelope aperture 5 respectively. Mating popper components 6A, 6B releasably secure the flap 4 to envelope 3.

A backing plate is provided in the form of a rectangular sheet of plastic 7 supporting a luminous surface 8.

In use an object such as glasses 10 can be placed in wallet 2 resting on surface 8 with flap 4 closed. In use, the luminous surface 8 glows in the dark identifying the container 1 and the shape of the glasses 10, allowing a person to locate the glasses 10 in the dark. A person can pick up the container in the dark and open flap 4 to access the glasses 10.

In FIG. 2, there is shown a luminous container 8 comprising a case body 2, a lid 1 and a drawer 3. The case is, for example, a glasses case. Luminous surface 5 is provided inside container body 2, and luminous surface 6 is provided inside drawer 3. Drawer 3 can be opened using knobs 4, and secured when closed using fastener 7. The luminous container 8, including drawer 3, is of transparent plastic. In use, objects such as glasses can be placed in container 8 on luminous surface 5, as well as, in addition, on luminous surface 6 in drawer 3. Thus, several objects may be supported (and made visible) owing to the additional luminous surface area. Drawer 3 may of course be closed when not required.

FIG. 3 shows a transparent luminous container 1 comprising case body 2 having luminous surface 7. The luminous surface 7 comprises glow in the dark paint painted on the bottom of case 2. Upper surface 5 comprises PVC, which towards the centre is gathered in folds 3 by elastic band 4 so as to provide elongated and expandable aperture 6. An object (not shown) can be inserted into, and withdrawn from, case body 2 through the aperture 6.

The luminous container may be used to store objects other than glasses, e.g. a mobile telephone, an inhaler, pills etc. The invention may take a form other than that specifically described above.

For example the container may be in the form of a glasses case supporting a surface which is luminous. In use the container is visible in the dark when the luminous surface glows.

Alternatively the container may be in the form of a plate supporting a peripheral skirt having an elasticated free edge. The plate supports a luminous surface. An object may be locatable in a pocket formed by the skirt with the object being insertable and withdrawn through the expandable aperture formed by the elasticated free edge. In use the container is visible in the dark when the luminous surface glows.

Further modifications will be apparent to those skilled in the art without departing from the scope of the present invention.

1-15. (canceled)

16. A luminous container for identifying objects in the dark comprising a container body to support one or more objects and a luminous surface on or in the container, wherein, in use, said luminous surface glows in the dark identifying the container and/or the or each object.

17. A container according to claim 16, which is a wallet of transparent material, said luminous surface being provided on a backing plate in the wallet.

18. A container according to claim 16, which is a glasses case, the case supporting a luminous surface.

19. A container according to claim 16, which container is in the form of a plate having an elasticated free edge supporting a peripheral skirt, wherein the plate supports the luminous surface, said object being locatable in a pocket formed by said skirt.

20. A container according to claim 16, which comprises a case for an object, which case comprises a luminous surface on or in the case, and a drawer comprising a further luminous surface in or on the drawer, the drawer when opened presenting an additional luminous surface.

21. A container according to claim 16, which comprises a case for an object, which case comprises a luminous surface on or in the case, and on one or more sides of the case an elasticated free edge forming an expandable aperture, said object being insertable into and withdrawable from said case through said aperture.

22. A container according to claim 16, wherein the container is formed from a transparent material.

23. A container according to claim 16, wherein the container is a bedside container.

24. A container according to claim 16, wherein the luminous surface comprises glow in the dark paint provided on one or more surfaces of the container.

25. A container according to claim 16, wherein the luminous surface comprises a luminous backing plate separate from the container.

26. A container according to claim 25 wherein the backing plate is a transparent plastic backing plate having glow in the dark paint on one or more surfaces thereof.

27. A container according to claim 19, wherein the elasticated free edge comprises polyvinylchloride (PVC) elasticated by an elastic band.

28. A container according to claim 16, wherein in use the object to be identified, or an outlined thereof, is rendered visible by the luminous surface.

29. Use of a luminous container according to claim 16, to enable location of an object in the dark.
